(19) United States
(12) Patent Application Publication
(10) Pub. No.: US 2010/0302437 A1
(43) Pub. Date: Dec. 2, 2010

(54) SOLID-STATE IMAGING UNIT, IMAGING APPARATUS, AND METHOD OF FIXING SOLID-STATE IMAGING DEVICE

(76) Inventor: Hideo KOBAYASHI, Saitama-shi (JP)

Correspondence Address: BIRCH STEWART KOLASCH & BIRCH, PO BOX 747, FALLS CHURCH, VA, 22040-0747, US

(21) Appl. No.: 12/785,952

(22) Filed: May 24, 2010

(30) Foreign Application Priority Data
May 27, 2009 (JP) P2009-128110

(51) Int. Cl. H04N 5/335

(52) U.S. Cl. 348/374; 348/E05.091

(57) ABSTRACT

An embodiment of the invention relates to a solid-state imaging unit including a solid-state imaging device and a supporting member that is provided on the rear side of the solid-state imaging device. An object of the invention is to provide a solid-state imaging unit that is positioned without being affected by a part error of the solid-state imaging device or the supporting member.

A CCD unit includes a CCD, a flexible board, and a CCD plate. The CCD plate is arranged on the rear side of the CCD so as not to contact the CCD, with the flexible board arranged between the CCD and the CCD plate. The CCD plate is adhered to the CCD in a non-contact state by an adhesive flowing from through holes (so-called adhesion with a gap).

### CROSS-REFERENCE TO RELATED APPLICATIONS

This application is based upon and claims the benefit of priority from the Japanese Patent Application No. 2009-128110 filed on May 27, 2009; the entire contents of which are incorporated herein by reference.

### BACKGROUND OF THE INVENTION

1. Field of the Invention

The present invention relates to a solid-state imaging unit including a solid-state imaging device and a supporting member arranged on the rear side of the solid-state imaging device, an imaging apparatus that includes the solid-state imaging unit and captures an object image, and a method of fixing a solid-state imaging device in the solid-state imaging unit.

2. Description of the Related Art

So-called digital cameras have been known which receive object light through an imaging optical system, form an object image on a solid-state imaging device using the object light, and acquire image signals indicating the object image. In addition, for example, a charge coupled device (CCD) image sensor or a complementary metal oxide semiconductor (CMOS) image sensor that is inexpensive and has low power consumption has been widely used as the solid-state imaging device. The solid-state imaging device needs to be positioned with respect to the imaging optical system such that the imaging surface of the solid-state imaging device intersects the optical axis at a right angle.

As the positioning technique, for example, a technique has been proposed which fixes the rear surface of the solid-state imaging device to the supporting member and attaches the supporting member to a holder of the imaging optical system to position the solid-state imaging device with respect to the imaging optical system during the assembly of a digital camera.

As a technique for fixing the supporting member to the rear surface of the solid-state imaging device, for example, a technique has been proposed in which a plurality of protruding portions is provided on the supporting member, an opening is provided in the vicinity of the protruding portions, the solid-state imaging device comes into contact with the plurality of protruding portions provided on the supporting member, and an adhesive flows into the gap between the solid-state imaging device and the supporting member through the opening formed in the vicinity of the protruding portions to adhere and fix the solid-state imaging device and the supporting member (for example, see JP-A-11-261904).

According to the technique disclosed in JP-A-11-261904, when the supporting member is fixed to the rear surface of the solid-state imaging device, it is difficult to absorb a part error of the solid-state imaging device or the supporting member even though the solid-state imaging device is accurately positioned with respect to the supporting member by a jig. Therefore, when this technique is used to attach the supporting member fixed to the rear surface of the solid-state imaging device to the holder of the imaging optical system, the imaging surface of the solid-state imaging device does not intersect the optical axis at a right angle but is included with respect to the optical axis due to a part error of the solid-state imaging device or the supporting member. That is, “the deviation of the imaging surface” occurs. As a result, there is a concern that the positional accuracy of the optical axis may be reduced.

### SUMMARY OF THE INVENTION

The invention has been made in order to solve the above-mentioned problems, and an object of the invention is to provide a solid-state imaging unit that is positioned without being affected by a part error of a solid-state imaging device or a supporting member, an imaging apparatus including the solid-state imaging unit, and a method of fixing a solid-state imaging device in the solid-state imaging unit.

According to an aspect of the invention, a solid-state imaging unit includes: a solid-state imaging device that receives object light and generates image signals indicating an object image; and a supporting member that is provided on the rear side of the solid-state imaging device so as not to contact the solid-state imaging device. The solid-state imaging device and the supporting member are adhered to each other in a non-contact state.

In the above-mentioned aspect, the term ‘solid-state imaging device’ means an image sensor, such as a CCD (Charge Coupled Device) image sensor or a CMOS (Complementary Metal Oxide Semiconductor) image sensor.

In the solid-state imaging unit according to the above-mentioned aspect, the solid-state imaging device and the supporting member are adhered to each other in a non-contact state (so-called adhesion with a gap). Therefore, the solid-state imaging device is positioned with respect to the supporting member without being affected by a part error of the solid-state imaging device or the supporting member.

In the solid-state imaging unit according to the above-mentioned aspect, the supporting member may have a through hole through which the rear surface of the solid-state imaging device is exposed, and the solid-state imaging device and the supporting member may be adhered to each other in a non-contact state by an adhesive flowing through the through hole.

According to the above-mentioned aspect, the solid-state imaging device and the supporting member are maintained in a non-contact state and the adhesive flows into the gap therebetween through the through hole. Therefore, the solid-state imaging device is reliably positioned with respect to the supporting member.

According to another aspect of the invention, there is provided an imaging apparatus that has an imaging optical system and captures an image using object light incident through the imaging optical system. The imaging apparatus includes: a solid-state imaging device that receives the object light and generates image signals indicating an object image; and a supporting member that is provided on the rear side of the solid-state imaging device so as not to contact the solid-state imaging device. The solid-state imaging device and the supporting member are adhered to each other in a non-contact state.

In the above-mentioned aspect, the term ‘solid-state imaging device’ means an image sensor, such as a CCD (Charge Coupled Device) image sensor or a CMOS (Complementary Metal Oxide Semiconductor) image sensor.

The imaging apparatus according to the above-mentioned aspect includes the solid-state imaging unit according to the above-mentioned aspect. Therefore, according to the imaging apparatus according to the above-mentioned aspect, similar to the solid-state imaging unit according to the above-mentioned aspect, the solid-state imaging device is positioned with respect to the supporting member without being affected by a part error of the solid-state imaging device or the supporting member. According to the imaging apparatus of the above-mentioned aspect, it is possible to prevent “deviation of the imaging surface” in which the imaging surface of the solid-state imaging device does not intersect the optical axis at a right angle but is included with respect to the optical axis due to a part error of the solid-state imaging device or the supporting member. As a result, it is possible to obtain high positional accuracy of the optical axis.

In the imaging apparatus according to the above-mentioned aspect, the supporting member may have a through hole through which the rear surface of the solid-state imaging device is exposed, and the solid-state imaging device and the supporting member may be adhered to each other in the non-contact state by an adhesive flowing through the through hole.

According to the above-mentioned aspect, the solid-state imaging device and the supporting member are maintained in a non-contact state and the adhesive flows into the gap therebetween through the through hole. Therefore, the solid-state imaging device is reliably positioned with respect to the supporting member.

According to still another aspect of the invention, there is provided a method of fixing a solid-state imaging device. The method includes: supporting a solid-state imaging device that receives object light and generates image signals indicating an object image and supporting a supporting member on the rear side of the solid-state imaging device so as not to contact the solid-state imaging device; positioning the solid-state imaging device; and adhering the solid-state imaging device and the supporting member in non-contact state.

In the above-mentioned aspect, the term ‘solid-state imaging device’ means an image sensor, such as a CCD (Charge Coupled Device) image sensor or a CMOS (Complementary Metal Oxide Semiconductor) image sensor.

In the method of fixing the solid-state imaging device according to the above-mentioned aspect, the solid-state imaging device and the supporting member are supported in a non-contact state, the solid-state imaging device is positioned, and the solid-state imaging device and the supporting member are adhered to each other in a non-contact state (so-called adhesion with a gap). Therefore, the solid-state imaging device is positioned with respect to the supporting member without being affected by a part error of the solid-state imaging device or the supporting member.

In the method of fixing the solid-state imaging device according to the above-mentioned aspect, the supporting member may have a through hole through which the rear surface of the solid-state imaging device is exposed, and the solid-state imaging device and the supporting member may be adhered to each other in a non-contact state by an adhesive flowing through the through hole.

According to the above-mentioned aspect, when the adhesive flows, a process error, such as a positional deviation of the solid-state imaging device or the supporting member, is less likely to occur. As a result, it is possible to reliably position the solid-state imaging device with respect to the supporting member.

According to the invention, it is possible to provide a solid-state imaging unit that is positioned without being affected by a part error of a solid-state imaging device or a supporting member, an imaging apparatus including the solid-state imaging unit, and a method of fixing a solid-state imaging device in the solid-state imaging unit.

### BRIEF DESCRIPTION OF THE DRAWINGS

FIG. 1 is a diagram illustrating the outward appearance of an imaging apparatus 1 including a CCD unit, which is an example of a solid-state imaging unit according to an embodiment of the invention;

FIG. 2 is a diagram illustrating the structure of an XY stage holding the CCD unit;

FIG. 3 is an enlarged view illustrating a flexible board shown in FIG. 2;

FIG. 4 is a diagram illustrating the structure of the XY stage holding the CCD unit;

FIG. 5 is a diagram illustrating the structure of the XY stage holding the CCD unit;

FIG. 6 is a diagram illustrating the structure of the XY stage holding the CCD unit;

FIG. 7 is a diagram illustrating the structure of the XY stage holding the CCD unit;

FIG. 8 is a diagram illustrating the structure of the XY stage holding the CCD unit;

FIG. 9 is a diagram illustrating the structure of the XY stage holding the CCD unit;

FIG. 10 is a diagram illustrating the structure of the XY stage holding the CCD unit;

FIG. 11 is a diagram illustrating the structure of the XY stage holding the CCD unit;

FIG. 12 is a diagram illustrating the structure of the XY stage holding the CCD unit;

FIG. 13 is a diagram illustrating the structure of the XY stage holding the CCD unit;

FIGS. 14A to 14D are diagrams illustrating the arrangement of magnets MG1 and MG2 and the positional relationship among bonded bodies YM1 and YM2, Hall elements h1 and h2, opposite yokes Y12 and Y22, and additional yokes Y13 and Y23;

FIG. 15 is a diagram illustrating the output of the Hall element during adjustment;

FIG. 16 is a diagram schematically illustrating a CCD fixing method, which is an example of a method of fixing a solid-state imaging device according to an embodiment of the invention;

FIG. 17 is a diagram schematically illustrating the CCD fixing method, which is an example of the method of fixing the solid-state imaging device according to the embodiment of the invention;

FIG. 18 is a diagram schematically illustrating the CCD fixing method, which is an example of the method of fixing the solid-state imaging device according to the embodiment of the invention;

FIG. 19 is a diagram schematically illustrating a CCD fixing method according to the related art; and

FIG. 20 is a diagram schematically illustrating the CCD fixing method according to the related art.

### DESCRIPTION OF THE PREFERRED EMBODIMENTS

Hereinafter, exemplary embodiments of the invention will be described with reference to the accompanying drawings.

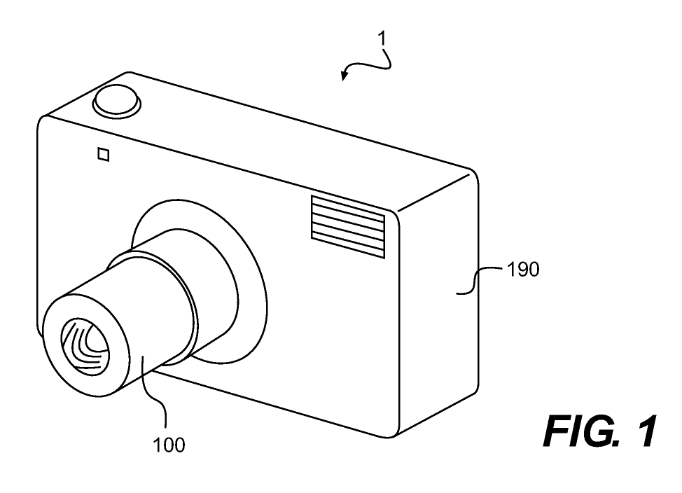

FIG. 1 is a diagram illustrating the outward appearance of an imaging apparatus 1 including a CCD unit 120, which is an example of a solid-state imaging unit according to an embodiment of the invention.

The imaging apparatus 1 shown in FIG. 1 is an example of an imaging apparatus according to the invention. In the imaging apparatus 1 shown in FIG. 1, the CCD unit 120 is supported by an XY stage 110, and when camera shake occurs during imaging, the XY stage is driven to move the CCD unit 120, thereby correcting the camera shake.

In the imaging apparatus shown in FIG. 1, the XY stage 110 holding the CCD unit 120 is arranged in the vicinity of a connection portion between a lens barrel 100 and a camera main body 190.

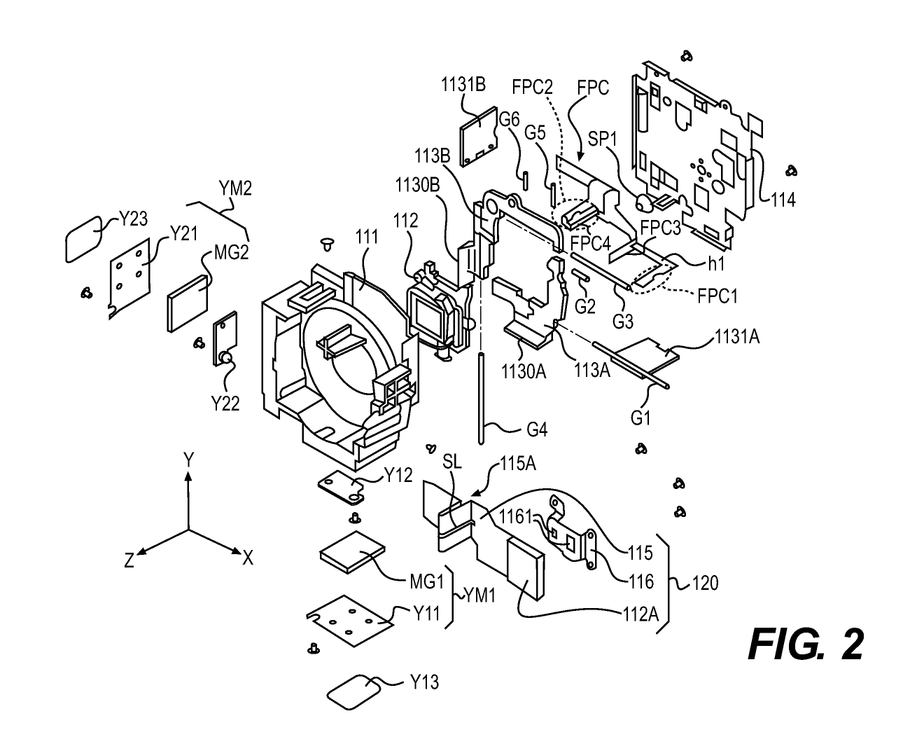

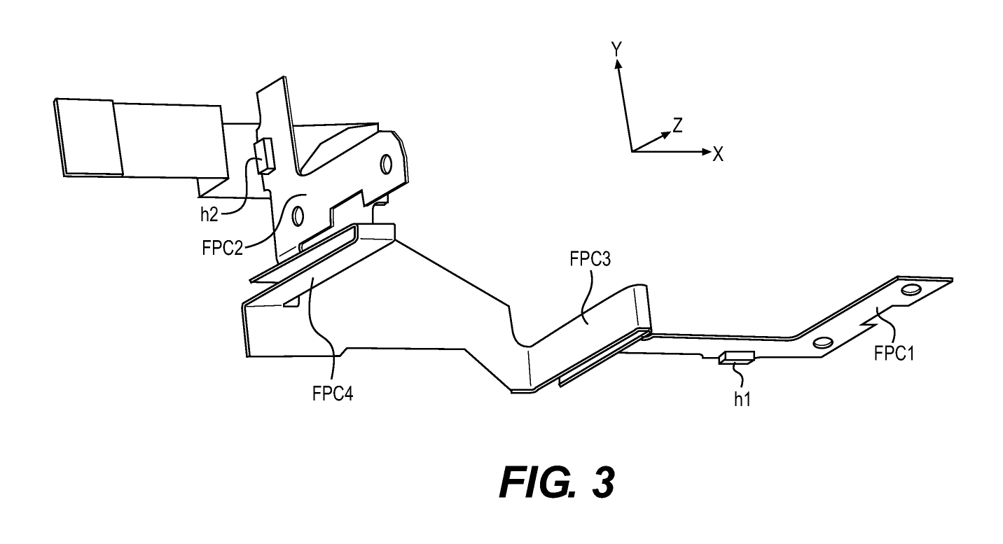

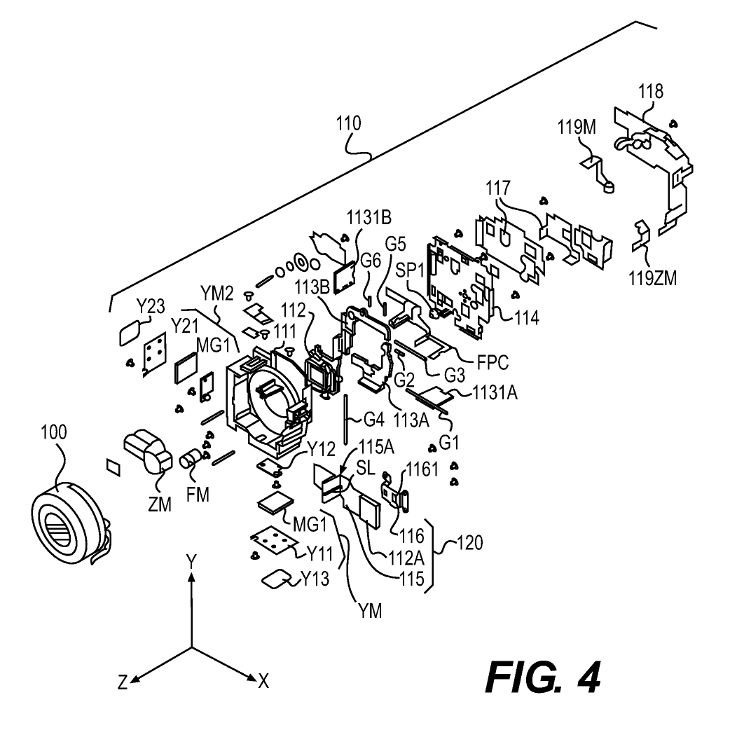

FIGS. 2 to 4 show an X axis, a Y axis, and a Z axis in order to clearly define the X direction and the Y direction of the XY stage 110. In FIGS. 2 and 4, three axes are aligned in the same directions. However, in FIG. 3, the three axes are aligned in directions different from those shown in FIGS. 2 and 4 for ease of understanding of the structure of the flexible board FPC. In the following description, the directions are represented by these axes.

FIG. 2 is an exploded view illustrating the XY stage 110 holding the CCD unit 120. FIG. 3 is an enlarged view illustrating the flexible board FPC shown in FIG. 2. FIG. 4 is an exploded view illustrating a lens barrel 100 incorporated with the XY stage 110, in addition to the exploded view of FIG. 2. In addition, FIG. 4 shows a zoom motor ZM, a focus motor FM, parts used to incorporate the motors with the lens barrel 100, a main FPC 118 for connection to a control unit of the imaging apparatus 1 shown in FIG. 1, and a dustproof tape 117.

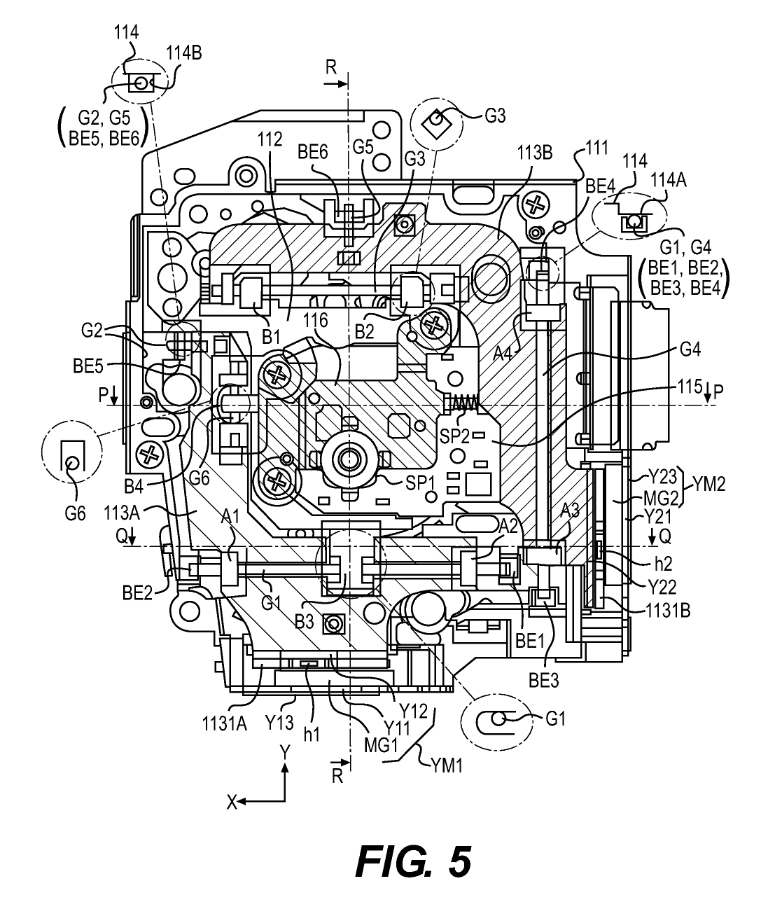

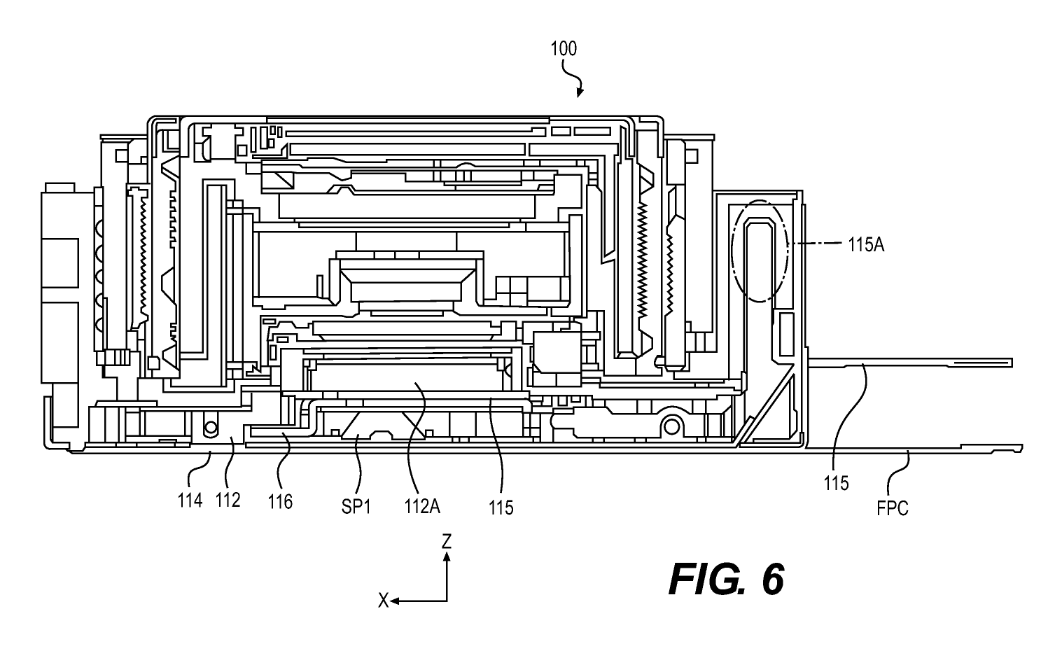

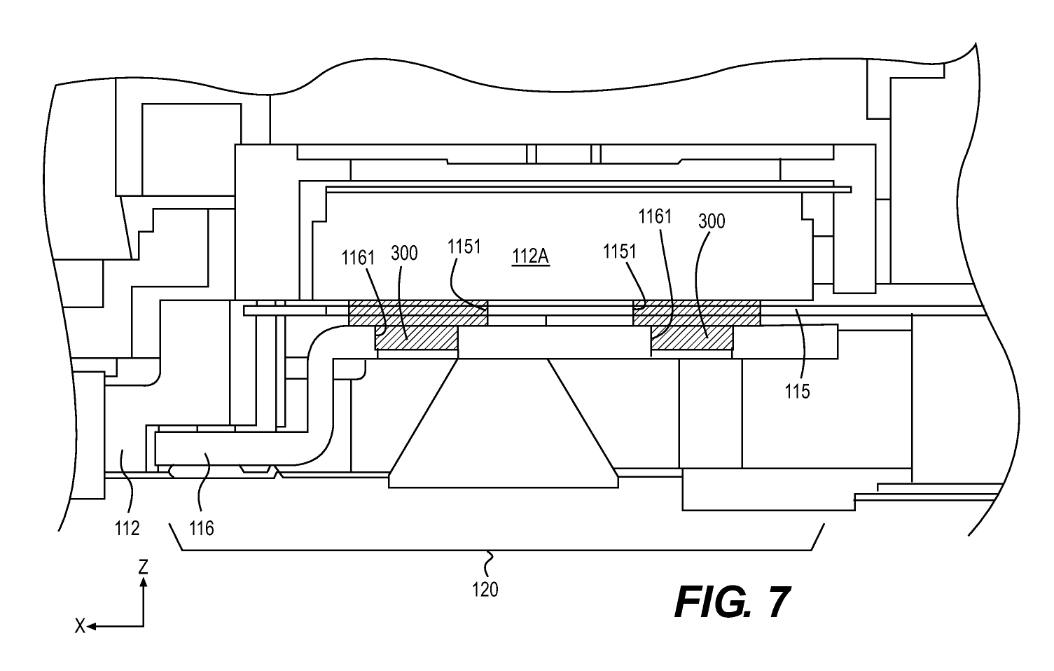

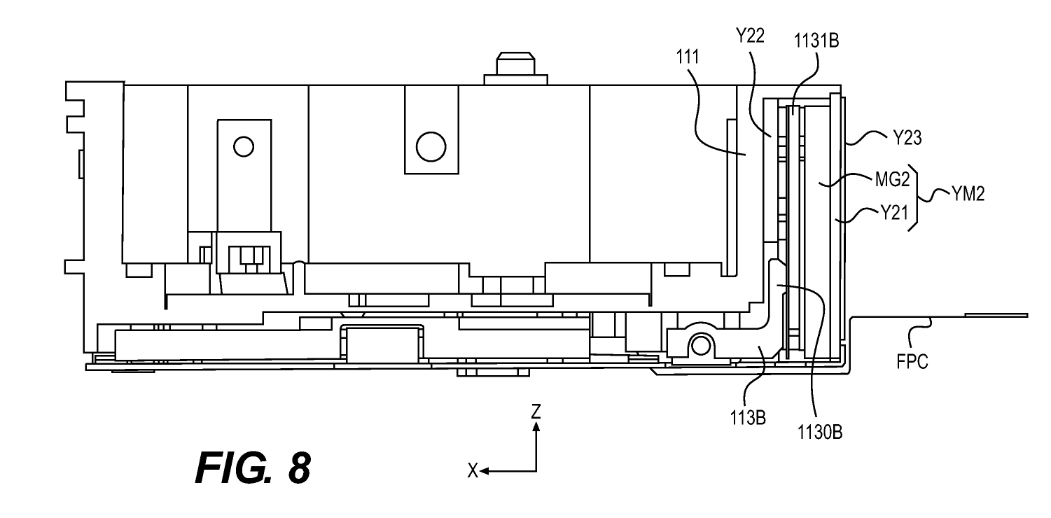

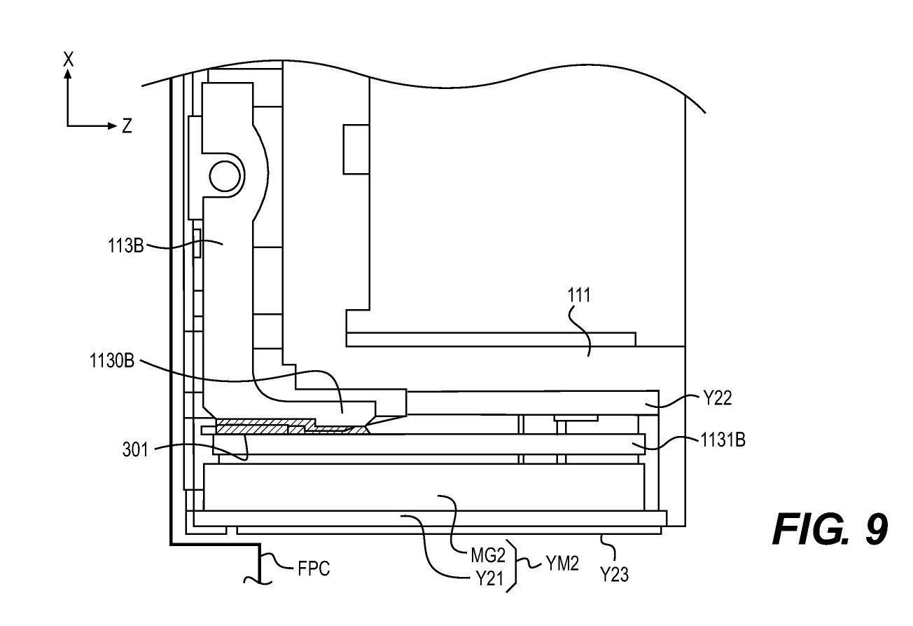

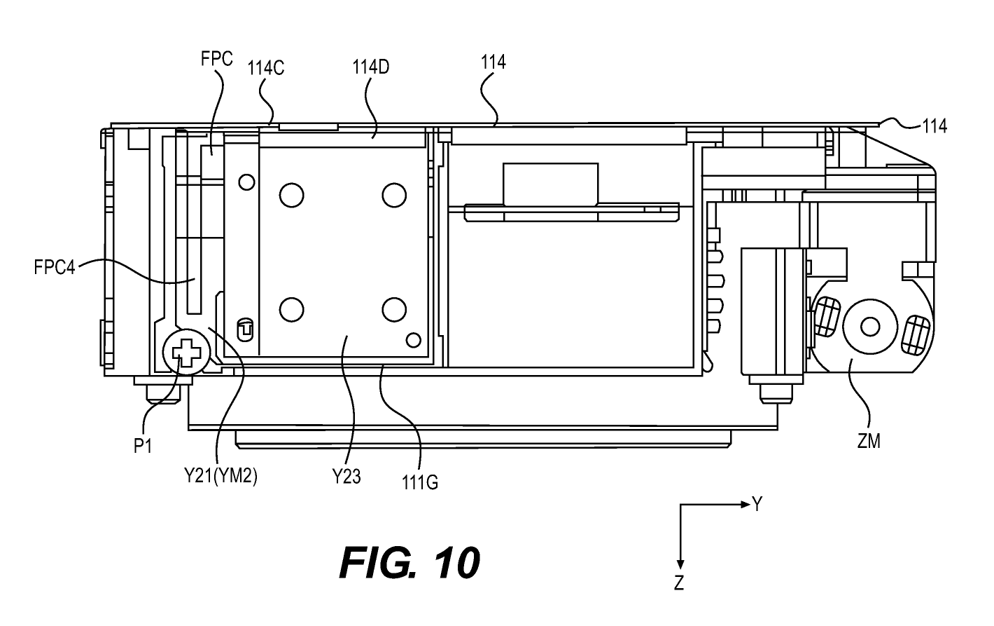

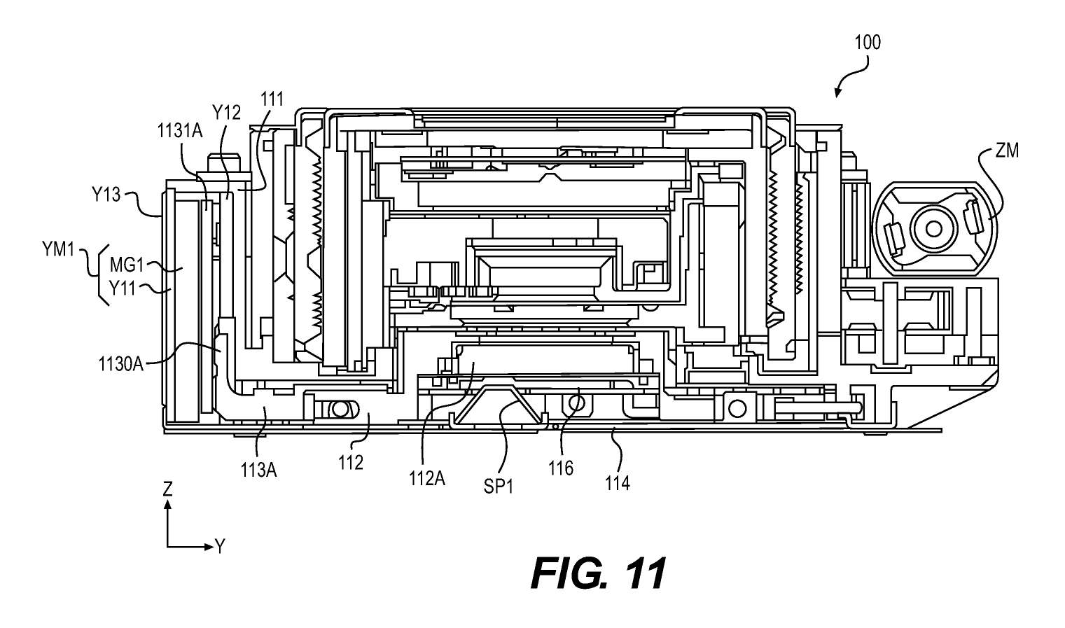

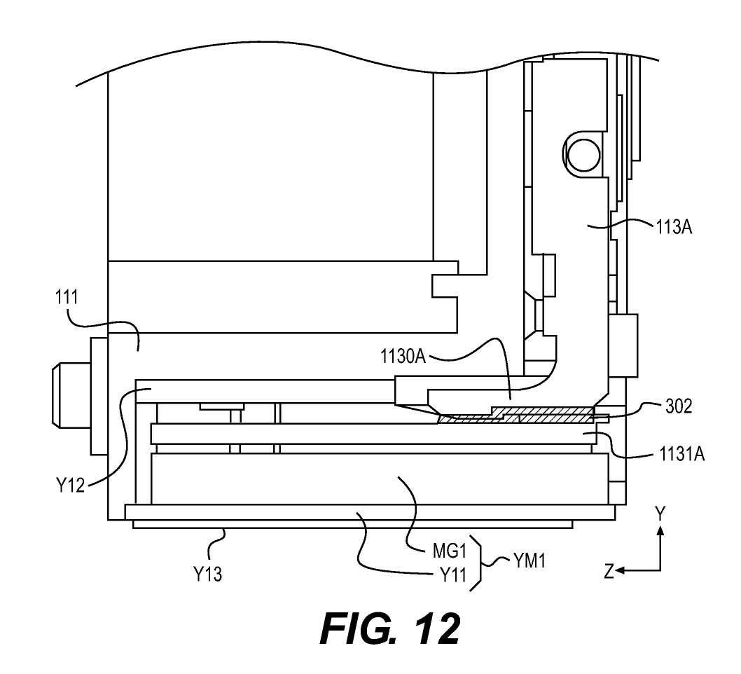

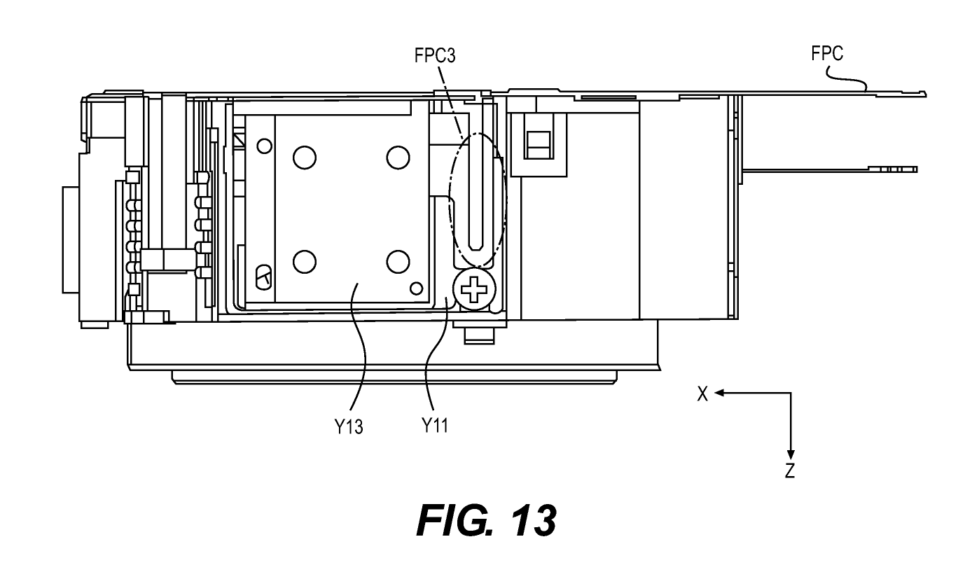

FIG. 5 is a diagram illustrating the assembled state of the XY stage 110 and the incorporated state of the XY stage 110 with the lens barrel 100 as viewed from a cover member 114 in the Z direction, in which the cover member 114 is transparently shown. FIG. 6 is an X cross-sectional view taken along the line P-P of FIG. 5. FIG. 7 is a partially enlarged cross-sectional view illustrating a portion of the X cross-sectional view. FIG. 8 is an X cross-sectional view taken along the line Q-Q of FIG. 5. FIG. 9 is a partially enlarged cross-sectional view illustrating a portion of the X cross-sectional view of FIG. 8. FIG. 10 is a right side view of FIG. 5 as viewed from the right side. FIG. 11 is a Y cross-sectional view take along the line R-R of FIG. 5. FIG. 12 is a partially enlarged cross-sectional view illustrating a portion of the Y cross-sectional view of FIG. 11. FIG. 13 is a bottom view of FIG. 5 as viewed from the bottom.

First, members forming the XY stage 110 and the structure of the XY stage 110 will be described with reference to FIGS. 2 and 4.

The XY stage 110 includes a plurality of members in addition to a base 111 shown in FIG. 2. Among the members, for example, the CCD unit 120, a CCD holder 112, an X stage 113A, and a Y stage 113B are mounted to the base 111 to form the XY stage 110. The assembled XY stage 110 is incorporated with the lens barrel 100 shown in FIG. 4 to form the structure shown in FIGS. 5 to 13.

The CCD holder 112, which is a moving stage, is shown at the center of FIG. 2. The CCD holder 112 holds the CCD unit 120.

The CCD unit 120 includes a CCD 112A, a flexible board 115, and a CCD plate 116. The CCD 112A is an example of a solid-state imaging device according to the invention, and the CCD plate 116 is an example of a supporting member according to the invention. The CCD 112A is a solid-state imaging device that receives object light and generates image signals indicating an object image. The flexible board 115 is soldered to the CCD 112A. The flexible board 115 is provided between the rear surface of the CCD 112A and the CCD plate 116. Through holes 1161 and 1151 for soldering (see FIG. 7) are provided in the CCD plate 116 and the flexible board 115. An adhesive flows into the through holes 1161 and 1151 such that the CCD plate 116 is adhered and fixed to the CCD 112A with a gap therebetween. The flexible board 115 is also fixed between the rear surface of the CCD 112A and the CCD plate 116 by an adhesive. The CCD unit 120 is fixed to the CCD holder 112 with the CCD plate 116 of the CCD unit 120 having the above-mentioned structure interposed therebetween. The fixation of the CCD unit 120 to the CCD holder 112 will be described below with reference to FIGS. 6 and 7. A bent portion 115A is provided in the flexible board 115 extending from the CCD 112A. A slit SL is provided in the bent portion 115A. Therefore, after the flexible board 115 is provided, the bent portion 115A absorbs X-direction stress applied to the flexible board 115 while the CCD 112A slides, and the slit SL absorbs Y-direction stress applied to the flexible board 115 when the CCD 112A slides.

In this embodiment, when each of the X stage 113A and the Y stage 113B slides, the CCD unit 120 including the CCD 112A, the flexible board 115, and the CCD plate 116 and the CCD holder 112 holding the CCD unit 120 slide.

The X stage 113A and the Y stage 113B that moves the CCD holder 112, which is a moving stage, in the X direction and the Y direction are shown at the center of FIG. 2. The X stage 113A shown in FIG. 2 surrounds half of the circumference of the central axis and is supported by the base 111 such that it can slide in the X direction. In addition, the X stage 113A restricts the movement of the CCD holder 112 in the X direction so as to be slidable in the Y direction, and slides in the X direction to move the CCD holder 112 in the X direction. The Y stage 113B shown in FIG. 2 surrounds half of the circumference of the central axis and is supported by the base 111 such that it can slide in the Y direction. In addition, the Y stage 113B restricts the movement of the CCD holder 112 in the Y direction so as to be slidable in the X direction, and slides in the Y direction to move the CCD holder 112 in the Y direction. The assembly of the stages 113A and 113B to the base 111 will be described with reference to FIG. 5. When the X stage 113A and the Y stage 113B slide, the known voice coil motor is used.

As known in the art, the voice coil motor includes a magnet, a coil, and a yoke. In this embodiment, the X stage 113A and the Y stage 113B includes a first board fixing portion 1130A and a second board fixing portion 1130B. A first coil board 1131A and a second coil board 1131B, which are moving bodies of the voice coil motor, are fixed to the board fixing portions 1130A and 1130B, respectively. Magnets MG1 and MG2, yokes Y11 to Y13 and Y21 to Y23, the X stage 113A, and the Y stage 113B for driving the coil boards 1131A and 1131B are mounted to the base 111 to form the voice coil motor. That is, an X stage driving mechanism and a Y stage driving mechanism are formed by the voice coil motor.

The magnets MG1 and MG2 and three kinds of yokes Y11 to Y13 and Y21 to Y23 respectively forming the X stage driving mechanism and the Y stage driving mechanism are shown outside the outer wall of the base 111 on the left side of FIG. 2 so as to correspond to the coil boards 1131A and 1131B of the X stage 113A and the Y stage 113B. Three kinds of yokes Y11 to Y13 and Y21 to Y23 are provided so as to correspond to the first coil board 1131A and the second coil board 1131B respectively provided in the X stage 113A and the Y stage 113B. Therefore, the yoke Y11 of the X stage driving mechanism is referred to as a first yoke, the yoke Y21 of the Y stage driving mechanism is referred to as a second yoke, the yoke Y12 of the X stage driving mechanism is referred to as a third yoke (since the yoke Y12 is arranged opposite to the first magnet MG1, it is also referred to as an opposite yoke), the yoke Y22 of the Y stage driving mechanism is referred to as a fourth yoke (since the yoke Y22 is arranged opposite to the second magnet MG2, it is also referred to as an opposite yoke), the yoke Y13 of the X stage driving mechanism is referred to as a first sub-yoke, and the yoke Y23 of the Y stage driving mechanism is referred to as a second sub-yoke. The first yoke Y11 is adhered and fixed to the first magnet MG1 and the second yoke Y21 is adhered and fixed to the second magnet MG2. Therefore, the first yoke Y11 and the first magnet MG1 fixed to each other are referred to as a first bonded body YM1, and the second yoke Y21 and the second magnet MG2 fixed to each other are referred to as a second bonded body YM2.

That is, the X stage driving mechanism includes the first bonded body YM1 including the first magnet MG1 that is opposite to the X stage 113A in the X-Z plane and the first yoke Y11 that is fixed to the rear surface of the first magnet MG1 as viewed from the X stage 113A, and the first coil board 1131A having a first coil which is fixed to the X stage 113A at a position facing the first magnet MG1, receives a current, and generates force to drive the X stage 113A in the X direction by interaction with the first magnet MG1. The Y stage driving mechanism includes the second bonded body YM2 including the second magnet MG2 that is opposite to the Y stage 113B in the Y-Z plane and the second yoke Y21 that is fixed to the rear surface of the second magnet MG2 as viewed from the Y stage 113B, and the second coil board 1131B having a second coil which is fixed to the Y stage 113B at a position facing the second magnet MG2, receives a current, and generates force to drive the Y stage 113B in the Y direction by interaction with the second magnet MG2.

The first yoke Y11 is a member that is wider than the first magnet MG1 in the X direction, and the X stage driving mechanism includes the first sub-yoke Y13 that is fixed to the rear surface of the first yoke Y11 as viewed from the first magnet MG1 at a position opposite to the first magnet MG1 and is narrower than the first yoke Y11 in the X direction. The second yoke Y21 is a member that is wider than the second magnet MG2 in the X direction, and the Y stage driving mechanism includes the second sub-yoke Y23 that is fixed to the rear surface of the second yoke Y21 as viewed from the second magnet MG2 at a position opposite to the second magnet MG2 and is narrower than the second yoke Y21 in the X direction.

Although not shown in the drawings, concave portions for accommodating the magnets MG1 and MG2 and three kinds of yokes Y11 to Y13 and Y21 to Y23 are provided in the outer wall of the base 111 so as to correspond to the X stage 113A and the Y stage 113B in a place where the X stage driving mechanism and the Y stage driving mechanism are shown in FIG. 2. The opposite yokes Y12 and Y22 are provided in the concave portions and screwed to the inner walls of the concave portions. Then, the first bonded body YM1 and the second bonded body YM2 respectively including the magnets MG1 and MG2 and the first yokes Y11 and Y22 are screwed to the outer wall of the base 111. The first and second sub-yokes Y13 and Y23 with lengths smaller than those of the first and second yokes in the X direction and the Y direction are fixed to the rear surfaces of the first and second yokes Y11 and Y22 of the first and second bonded bodies as viewed from the magnets at positions opposite to the magnets. The coil boards 1131A and 1131B respectively fixed to the board fixing portions 1130A and 1130B of the X stage 113A and the Y stage 113B are arranged around the outer wall of the base 111 in the gap between the first and second bonded bodies YM1 and YM2 and the opposite yokes Y13 and Y23 that is disposed opposite to the surfaces of the bonded bodies. In this way, the X stage 113A and the Y stage 113B are mounted to the base 111.

Therefore, when power is supplied to the coil boards 1131A and 1131B, the coil boards 1131A and 1131B slide along the magnets MG1 and MG2 in the horizontal direction (the X direction and the Y direction) by the Fleming's left-hand rule. As a result, the CCD holder 112, which is a moving stage, and the CCD unit 120 held by the CCD holder 112 are moved with the movement of the coil boards 1131A and 1131B fixed to the board fixing portions 1130A and 1130B of the stages 113A and 113B.

In this way, the X stage 113A, the Y stage 113B, and the CCD holder 112 are mounted on the base 111 such that they can be rapidly operated in response to the supply of power to the coil boards 1131A and 1131B.

Next, how to mount guide shafts G1, G3, G4, and G6 and support shafts G2 and G5 inserted or fixed to the X stage 113A and the Y stage 113B to the base 111 will be described briefly.

First, how to arrange and mount two guide shafts G1 and G3 and one support shaft G2 extending in the X direction to the base 111 will be described briefly with reference to FIG. 2.

First, two bearings (which will be described below) are provided in the X stage 113A. The first guide shaft G1 that extends in the X direction and is fixedly supported by the base 111 is inserted into the two bearings such that both ends of the first guide shaft G1 are fitted to the bearings of the base 111. In this way, the first guide shaft G1 is fixedly supported by the base 111. In addition, one end of the first support shaft G2 that protrudes in the X direction and is supported by the base 111 so as to be slidable in the X direction is fixedly supported by the X stage 113A. Both ends of the first guide shaft G1 are fitted to U-groove-shaped bearings of the base 111 and are pressed by a pressing portion (which will be described below) of a cover member 114. In this way, the first guide shaft G1 is fixedly supported by the base 111.

Both ends of the second guide shaft G3 extending in the X direction are fixedly supported by the Y stage 113B, and two bearings (which will be described below) provided in the CCD holder 112 are connected to the second guide shaft G3 so as to be slidable in the X direction. In this way, the CCD holder 112 is connected to the Y stage 113B. The second guide shaft G3 restricts the movement of the CCD holder 112, which is a moving stage, in the Y direction and guides the movement of the CCD holder 112 only in the X direction.

Among three shafts extending in the Y direction, both ends of the third guide shaft G6 are fixed to the X stage 113A, and another bearing (which will be described below) provided in the CCD holder 112 is connected to the third guide shaft G6 so as to be slidable in the Y direction. In this way, the CCD holder 112 is connected to the X stage 113A. The third guide shaft G6 extending in the Y direction is fixedly supported by the X stage 113A to restrict the movement of the CCD holder 112 in the X direction and guide the movement of the CCD holder 112 only in the Y direction.

The fourth guide shaft G4 is inserted into two bearings provided in the Y stage 113B and both ends of the fourth guide shaft G4 are fitted to a U-groove-shaped bearing of the base 111 and are pressed by a pressing portion (which will be described below) of the cover member 114. In this way, the fourth guide shaft G4 is fixedly supported by the base 111. In addition, the second support shaft G5 is fixed to the Y stage 113B.

In this way, the guide shafts G1 and G4 and the support shafts G2 and G5 for slidably moving the stages 113A and 113B and the CCD holder 112, which is a moving stage, are mounted to the base 111 and the guide shafts G3 and G6 for restricting the movement of the CCD holder 112 in one direction are fixedly supported by the Y stage 113B and the X stage 113A, respectively. In this way, the stages 113A and 113B and the CCD holder 112 are mounted to the base 111. The base 111 having the members mounted thereon will be described in detail with reference to FIG. 5.

Wiring lines for supplying power to the coils on the coil boards 1131A and 1131B need to be provided on the coil boards 1131A and 1131B of the stages. FIG. 2 shows the flexible board FPC for power supply. As shown in FIG. 3, the flexible board FPC includes a first fixing portion FPC1 that is fixed to the first coil board 1131A and has a current path to the first coil formed therein and a second fixing portion FPC2 that is fixed to the second coil board 1131B and has a current path to the second coil formed therein. In this embodiment, one flexible board FPC is used for connection to two coil boards 1131A and 1131B. However, two individual flexible boards FPC may be used.

The one flexible board FPC shown in FIG. 3 includes a first bent portion FPC3 that is bent in the Z direction such that two surfaces face each other in the X direction and a second bent portion FPC4 that is bent in the Z direction such that two surfaces face each other in the Y direction. A first Hall element h1 and a second Hall element h2 that detect the magnetic force of the first and second magnets MG1 and MG2 to detect the positions of the X stage and the Y stage in the X direction and the Y direction are provided in portions of the flexible board FPC fixed to the first and second coil boards 1131A and 1131B. Therefore, a transmission path through which detection signals obtained by the Hall elements h1 and h2 is also formed on the flexible board FPC.

When the X stage 113A is moved in the X direction, the first bent portion FPC3 absorbs stress applied to the flexible board FPC. When the Y stage 113B is moved in the Y direction, the second bent portion FPC4 absorbs stress applied to the flexible board FPC in the Y direction.

When wiring by the flexible board FPC ends, finally, the cover member 114 is provided so as to cover the X stage 113A, the Y stage 113B, and the CCD holder 112 in the Z direction. In this way, the assembly process ends.

The state after the CCD unit 120, the CCD holder 112, and the stages 113A and 113B are mounted on the base 111 to form the XY stage 110 and the XY stage 110 is incorporated with the lens barrel 100 will be described with reference to FIG. 5.

As described above, FIG. 5 shows the incorporated state of the XY stage 110 with the lens barrel 100, as viewed from the upper right side of FIGS. 2 and 4, that is, in the Z direction, in which the cover member 114 is transparently shown.

As described with reference to FIG. 2, the first to fourth guide shafts G1, G3, G4, and G6 and the first and second support shafts G2 and G5 are mounted to the stages 113A and 113B and the base 111, and each stage is supported by the base 111. Therefore, first, the structure around the guide shafts G1, G3, G4, and G6 and the support shafts G2 and G5 will be described.

As shown in FIG. 5, two bearings A1 and A2 and two bearings A3 and A4 into which the first guide shaft G1 and the fourth guide shaft G4 are inserted are provided in the X stage 113A and the Y stage 113B respectively.

The base 111 shown in FIG. 5 includes: two first support portions BE1 and 8E2 with a U-groove shape that fixedly support both ends of the first guide shaft G1 and are opened toward the cover member 114; two second support portions BE3 and BE4 with a U-groove shape that fixedly support both ends of the fourth guide shaft G4 and are opened toward the cover member 114; a third support portion BE5 with a U-groove shape that supports the first support shaft G2 so as to be slidable in the X direction and is opened toward the cover member 114; and a fourth support portion BE6 with a U-groove shape that supports the second support shaft G5 in the Y direction so as to be slidable in the X direction and is opened toward the cover member 114. The first support portions BE1 and BE2 and the second support portions BE3 and BE4 have the same structure and the third support portion BE5 and the fourth support portion BE6 have the same structure. Therefore, FIG. 5 is an enlarged view illustrating the structure of the support portion BE4 of the second support portions BE3 and BE4 and the structure of the third support portion BE5. In addition, FIG. 5 is an enlarged view illustrating the structure of two bearings B1 and B2 supported by the second guide shaft G3 of the CCD holder 112 and the structure of one bearing B3 supported by the first guide shaft G1 of the CCD holder 112.

That is, the first guide shaft G1 is inserted into the two bearings A1 and A2 of the X stage 113A such that both ends of the first guide shaft G1 are fitted to the first support portions BE1 and BE2, and the first guide shaft G1 and the X stage 113A are supported by the base 111. The fourth guide shaft G4 is inserted into the bearings A3 and A4 of the Y stage 113B such that both ends of the fourth guide shaft G4 are fitted to the second support portions BE3 and BE4, and the fourth guide shaft G4 and the Y stage 113B are supported by the base 111.

As described above, the cover member 114 includes: two first pressing portions 114A that press portions of the first guide shaft G1 supported by the two first support portions BE1 and BE2; two first pressing portions 114A that press portions of the fourth guide shaft G4 supported by the two second support portions BE3 and BE4; a first closing piece that closes an opening of the third support portion BE5 formed toward the cover member 114 and forms a first support hole 114B into which the first support shaft G2 is inserted together with the third support portion BE5; and a second closing piece that closes an opening of the fourth support portion BE6 formed toward the cover member 114 and forms a second support hole 114B into which the second support shaft G5 is inserted together with the fourth support portion BE6. In this way, the cover member 114 is closed from the surface side of FIG. 5. Therefore, the X stage 113A and the Y stage 113B are appropriately supported by the cover member 114 and the bearings formed in the base 111.

In addition, the cover member 114 includes a spring member SP1 serving as an urging member that is fixed to the cover member 114 and urges the CCD holder 112 in the Z direction. As shown in the enlarged view of FIG. 5, rectangular through holes into which the second guide shaft G3 is inserted and have angles in the Z direction and the Y direction are provided in two bearings B1 of B2 of the CCD holder 112 supported by the second guide shaft G3. In this way, the round second guide shaft G3 is pressed by two points of two sides among four sides of the rectangle, and is supported such that rattling in the Y direction is absorbed and friction is reduced.

A spring SP2 serving as an urging member that urges the CCD holder 112 relative to the X stage 113A in the X direction is provided, and the spring SP2 urges the CCD holder 112 in the X direction. In this way, since the X stage 113A is constantly urged in one direction, rattling in the X direction when the CCD holder 112, which is a moving stage, is moved is absorbed.

In this way, the CCD holder 112 is appropriately supported such that the rattling of the CCD holder 112 during sliding is prevented by the spring SP1, the bearings connecting the X stage 113A, the Y stage 113B and the base 111, and the bearings connecting the X stage 113A, the Y stage 113B, and the CCD holder 112.

The assembled structure has been described with reference to FIG. 2, but the structure of the X stage driving mechanism and the Y stage driving mechanism will be described with reference to FIG. 5 for more clarity of the assembled structure.

As described above, the X stage driving mechanism shown in FIG. 5 includes the first bonded body YM1 including the first magnet MG1 that is opposite to the X stage 113A in the X-Z plane and the first yoke Y11 that is fixed to the rear surface of the first magnet MG1 as viewed from the X stage 113A, and the first coil board 1131A having the first coil which is fixed to the X stage 113A at a position facing the first magnet MG1, receives a current, and generates force to drive the X stage 113A in the X direction by interaction with the first magnet MG1. The Y stage driving mechanism includes the second bonded body YM2 including the second magnet MG2 that is opposite to the Y stage 113B in the Y-Z plane and the second yoke Y21 that is fixed to the rear surface of the second magnet MG2 as viewed from the Y stage 113B, and the second coil board 1131B having the second coil which is fixed to the Y stage 113B at a position facing the second magnet MG2, receives a current, and generates force to drive the Y stage 113B in the Y direction by interaction with the second magnet MG2.

The first yoke Y11 is a member that is wider than the first magnet MG1 in the X direction, and the X stage driving mechanism includes the first sub-yoke Y13 that is fixed to the rear surface of the first yoke Y11 as viewed from the first magnet MG1 at a position opposite to the first magnet MG1 and is narrower than the first yoke Y11 in the X direction. The second yoke Y21 is a member that is wider than the second magnet MG2 in the Y direction, and the Y stage driving mechanism includes the second sub-yoke Y23 that is fixed to the rear surface of the second yoke Y21 as viewed from the second magnet MG2 at a position opposite to the second magnet MG2 and is narrower than the second yoke Y21 in the Y direction.

In this way, the first coil board 1131A and the second coil board 1131B fixed to the first board fixing portion 1130A and the second board fixing portion 1130B are appropriately provided between the first magnet MG1 and the second yoke Y12 opposite to the first magnet MG1 and between the second magnet MG2 and the fourth yoke Y22 opposite to the second magnet MG2, respectively, and the voice coil motor for driving each stage and the stages are mounted to the base 111.

In this embodiment, the first sub-yoke Y13 is provided on the rear surface of the first yoke Y11 opposite to the magnet MG1 and second sub-yoke Y23 is provided on the rear surface of the second yoke Y21 opposite to the magnet MG2, in addition to the arrangement in which the first yoke Y11 and the third yoke Y12 are opposite to each other with the magnet MG1 interposed therebetween and the second yoke Y21 and the fourth yoke Y22 are opposite to each other with the magnet MG2. In this way, it is possible to minimize the leakage of magnetic flux when the coil is driven. Therefore, it is possible to effectively apply a magnetic force to the coil boards 1131A and 1131B.

In this way, the guide shafts G1, G3, G4, and G6, the support shafts G2 and G5, the X driving mechanism, and the Y driving mechanism are mounted to the base 111 to form the XY stage 110.

Next, the structure of the XY stage 110 incorporated with the lens barrel 100 and the positional relationship between the members of the XY stage 110 will be described with reference to FIGS. 5 to 13.

FIG. 6 is an X cross-sectional view taken along the line P-P of FIG. 5. FIG. 7 is a partially enlarged cross-sectional view illustrating a portion of the X cross-sectional view of FIG. 6. FIG. 8 is an X cross-sectional view taken along the line Q-Q of FIG. 5. FIG. 9 is a partially enlarged cross-sectional view illustrating a portion of the X cross-sectional view of FIG. 8. FIG. 10 is a right side view of FIG. 5 as viewed from the right side. FIG. 11 is a Y cross-sectional view take along the line R-R of FIG. 5. FIG. 12 is a partially enlarged cross-sectional view illustrating a portion of the Y cross-sectional view of FIG. 11. FIG. 13 is a bottom view of FIG. 5 as viewed from the bottom.

As shown in FIGS. 6 and 11, the XY stage 110 is incorporated with the rear side of the lens barrel 100, and the CCD plate 116 and the CCD holder 112 are urged to the lens barrel 100 by the spring SP1 provided in the cover member 114 that is mounted last. In this way, the members of the XY stage 110 are incorporated with the lens barrel 100.

As shown in FIGS. 6 and 7, the CCD 112A is mounted to the CCD holder 112 and the flexible board 115 is soldered to the CCD 112A. When the flexible board 115 is exposed to the outside and the CCD 112A is moved together with the CCD holder 112, the flexible board 115 is likely to be scratched. Therefore, in this embodiment, the flexible board 115 is provided between the CCD 112A and the CCD plate 116. The CCD plate 116 is pressed against the CCD holder 112 by the spring SP1 of the cover member 114 to correct the position of the flexible board 115.

As described above, the CCD plate 116 that presses the flexible board 115 against the rear surface of the CCD 112A has through holes 1161 through which the rear surface of the CCD 112A is exposed. In addition, the flexible board 115 has through holes 1151 through which the rear surface of the CCD 112A is exposed. The CCD plate 116 is arranged on the rear side of the CCD 112A so as not to contact the CCD 112A, with the flexible board 115 arranged between the CCD 112A and the CCD plate 116, and is adhered to the CCD 112A in a non-contact state by an adhesive 300 flowing through the through holes 1161 and 1151 (so-called adhesion with a gap). As such, an assembly of the flexible board 115, the CCD plate 116, and the CCD 112A obtained by bonding the CCD 112A to the CCD plate 116 so as not to contact with each other with the flexible board 115 interposed therebetween is the CCD unit 120. A CCD fixing method of fixing the CCD plate 116 to the rear surface of the CCD 112A will be described below with reference to FIGS. 16 to 18.

As described about with reference to FIG. 2, the bent portion 115A with a U shape in the X direction is provided in the flexible board 115, and the U-shaped bent portion 115A is provided in a space between the cover member 114 and the base 111. As described above, the slit SL extending in the Y direction is provided in a portion of the flexible board 115 in which the bent portion 115A is provided. Therefore, even when stress is applied to the flexible board 115 in the X direction and the Y direction during the sliding of the CCD holder 112, the stress is reduced by the bent portion 115A and the slit SL (see FIG. 2). In addition, it is not necessary to increase the size of the base 111 in order to ensure a wiring space. Therefore, it is possible to reduce the size of the XY stage 110.

As described with reference to FIG. 2, FIGS. 8 and 9 show the state after the opposite yoke (fourth yoke) Y22 screwed to the inner wall of the concave portion formed in the outer wall of the base 111 and the second bonded body YM2 including the magnet MG2 and the second yoke Y21 bonded to each other is fixed to the outer wall of the base 111.

The Y stage 113B includes the second board fixing portion 1130B which is provided so as to turn around the outer wall of the base 111 extends in the Z direction and the Y direction, and has a length in the Z direction smaller than that of the base 111 in the Z direction and to which the second coil board 1131B is fixed. In this embodiment, the second board fixing portion 1130B and the second coil board 1131B are adhered and fixed to each other by the adhesive 301 so as not to contact each other (so-called adhesion with a gap). The second coil board 1131B may be a printed coil or a wire coil.

The Y stage driving mechanism includes the fourth yoke Y22 that is provided between the outer wall of the base 111 and the second coil board 1131B at a position where there is no interference with the second board fixing portion 1130B in the Z direction.

The second coil board 1131B is inserted in the gap between the magnet MG2 and the opposite yoke (fourth yoke) Y22 so as to turn around the outer wall of the base 111. The second bonded body YM2 obtained by bonding the second yoke Y21 to the rear surface of the magnet MG2 is mounted to the base 111.

When the Y stage 113B connected to the second coil board 1131B shown in FIGS. 8 and 9 is moved together with the second coil board 1131B toward the plane of FIGS. 8 and 9 from the front side to the rear side or the rear side to the front side, the Y stage 113B slides in the Y direction.

As shown in FIGS. 11 and 12, the structure of the X stage 113A is the same as that of the Y stage 113B described with reference to FIGS. 8 and 9 and a detailed description thereof will be omitted. In this embodiment, the first board fixing portion 1130A and the first coil board 1131A are bonded and fixed to each other by an adhesive 302 so as not to contact each other (so-called adhesion with a gap). The first coil board 1131A may be a printed coil or a wire coil.

As such, in this embodiment, the voice coil motor forming the X stage driving mechanism and the voice coil motor forming the Y stage driving mechanism are closely provided in a very narrow space. Therefore, a driving mechanism with a size smaller than that of the related art is mounted to the XY stage 110. As a result, it is possible to reduce the size of the XY stage 110.

In this embodiment, a structure capable of simply adjusting the output of the Hall elements h1 and h2 (to obtain linearity) is used in order to accurately detect the positions of the coil boards 1131A and 1131B, that is, the position of each stage, using the Hall elements h1 and h2 provided on the flexible board FPC. The structure will be described below.

FIG. 10 is a right side view of FIG. 5. The Y stage driving mechanism that drives the Y stage 113B is shown on the right side of FIG. 5. FIG. 10 shows the first yoke Y21 included in the Y stage driving mechanism and an additional yoke Y23 adhered to the rear surface of the first yoke Y21. As described above, the first yoke Y21 is adhered and fixed to the inner magnet MG2. Since the X stage driving mechanism has the same structure as the Y stage driving mechanism, only the structure of the Y stage driving mechanism shown in FIG. 10 will be described.

FIG. 10 shows the second bent portion FPC4 of the flexible board FPC that is appropriately provided in a small space between the base 111 and the lens barrel 100.

As described above, the Y stage driving mechanism for driving the coil board supplied with power through the flexible board FPC in the magnetic field is mounted on the base 111. FIG. 10 shows the second yoke Y21 and the second sub-yoke Y23 of the Y stage driving mechanism. As described above, the magnet MG2 (see FIG. 5) is adhered and fixed to the second yoke Y21 to form the second bonded body YM2.

The base 111 shown in FIG. 10 includes a guide portion 111G that comes into contact with one side of the second bonded body YM2 that extends in the Y direction and serves as a guide when the position of the second bonded body in the Y direction is adjusted. The cover member 114 includes a guide piece 114C that is opposite to the guide portion 111G of the base 111 with the second bonded body YM2 interposed therebetween and serves as a guide in cooperation with the guide portion 111G when the position of the second bonded body YM2 in the Y direction is adjusted. The cover member 114 further includes a first rear surface guide portion 114D that comes into contact with the rear surface of the second bonded body as viewed from the Y stage 113B and guides the rear surface of the second bonded body.

Next, the structure of a portion adjusting sensitivity will be described with reference to the drawings which are referred to at random.

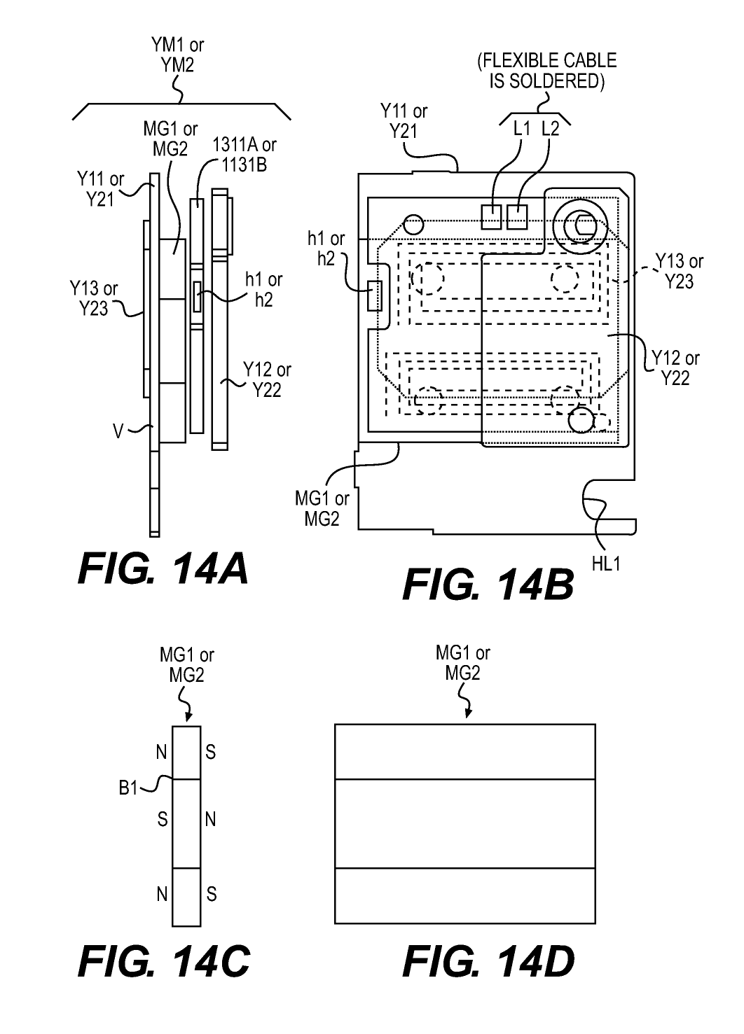

FIGS. 14A to 14D are diagrams illustrating the structure of the magnets MG1 and MG2 and the positional relationship among the bonded bodies YM1 and YM2, the Hall elements h1 and h2, the first, third, second, and fourth yokes Y11, Y12, Y21, and Y22, and the first and second sub-yokes Y13 and Y23.

FIG. 14A shows the positional relationship among the coil boards 1131A and 1131B and the yokes Y11 to Y13 and Y21 to Y23 shown in FIGS. 8 and 9 and the positions of the Hall elements h1 and h2. FIG. 14B shows the positional relationship among the first yoke Y11 or the second yoke Y21, the third yoke Y12 or the fourth yoke Y22, and the first coil board 1131A or the second coil board 1131B. FIGS. 14C and 14D show the arrangement of the magnet MG1 or MG2.

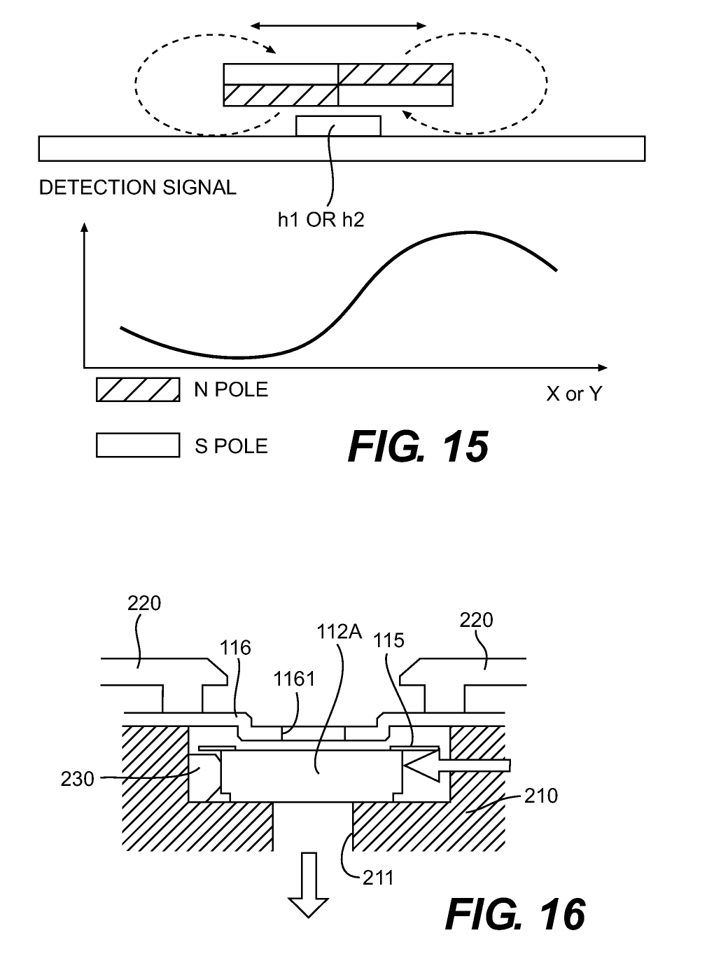

FIG. 15 is a diagram illustrating a variation in the output of the Hall element h1 or h2 when the bonded body is moved along the guide 111G shown in FIG. 10 (in the direction of an arrow in FIG. 15).

A long hole HL1 that communicates with a screw hole formed in the base 111 and forms an engaging portion is provided in the first bonded body YM1 or the second bonded body YM2. An eccentric pin P1 is inserted into the long hole HL1 and the bonded body YM1 or YM2 is moved in the X direction or the Y direction along the guide 111G (see FIG. 10) to perform position adjustment. After the position adjustment is performed, the eccentric pin is removed and a screw is inserted into the engaging portion to fix the first and second bonded bodies to the base 111.

As shown in FIG. 14A, the X stage driving mechanism or the Y stage driving mechanism includes the first sub-yoke Y13 or the second sub-yoke Y23 that is wider than the first magnet MG1 or the second magnet MG2 in the X direction or the Y direction, is narrower than the first yoke Y11 or the second yoke Y21 in the X direction and the Y direction, and is fixed to the rear surface of the first yoke Y11 or the second yoke Y21 of the first bonded body YM1 or the second bonded body YM2 as viewed from the first magnet MG1 or the second magnet MG2 at a position opposite to the first magnet MG1 or the second magnet MG2. The sub-yokes Y13 and Y23 are provided at positions capable of covering the range in which the polarities of the magnets MG1 and MG2 are changed (see FIG. 14C). When the thicknesses of the first yoke and the second yoke increase, the sizes of the yokes increase. Therefore, the thicknesses of the first yoke and the second yoke are reduced and the first sub-yoke Y13 and the second sub-yoke Y23 are provided only at a necessary position. In this way, it is possible to provide the yokes in a narrow space and reduce the leakage of magnetic flux from a magnetic circuit formed by the magnets MG1 and MG2 and the yokes Y11 to Y13 and Y21 to Y23. Therefore, it is possible to effectively apply a magnetic force to the coil.

As shown in FIGS. 14C and 14D, in the voice coil motor according to this embodiment, dipole (S and N) magnets are alternately provided. When each stage is disposed at the center of the stroke range of the stage, the position of each bonded body is adjusted such that the Hall elements h1 and h2 are disposed at a position (represented by B1 in FIG. 14C) facing the boundary between the N pole and the S pole of the dipole magnets. The coil boards 1131A and 1131B are moved only in the range in which the Hall elements h1 and h2 face the S pole, which is the upper side of the boundary (B1) between the magnets, and the N pole, which is the lower side of the boundary.

FIG. 15 shows a variation in the output of the Hall elements h1 and h2 when the bonded body is moved during adjustment.

For example, the output of the Hall elements h1 and h2 is electrically monitored. The bonded bodies YM1 and YM2 are moved in one direction and the maximum output of the Hall elements h1 and h2 is detected. When the maximum output is detected, the bonded bodies are moved in the opposite direction and the minimum output of the Hall elements h1 and h2 is detected. When the maximum and minimum outputs are both obtained, the output value is divided by 2 and the bonded body is moved at the position where the value is obtained. Then, the Hall elements h1 and h2 are adjusted so as to be disposed at a position facing the boundary (the boundary represented by B1 in FIG. 14C) between the N pole and the S pole of the magnets MG1 and MG2.

When the adjustment is performed, the output of the Hall elements h1 and h2 is not saturated even though the coil board is actually moved at the maximum stroke, and the output of the Hall elements h1 and h2 is linearly obtained according to variation in position. Therefore, it is possible to significantly improve the detection accuracy of position.

In this way, the voice coil motors are closely mounted in a narrow space while maintaining the driving force.

Next, the structure of the XY stage 110 will be described with reference to FIGS. 11 to 13.

FIG. 11 is a Y cross-sectional view taken along the line R-R of FIG. 5, and FIG. 12 is a partially enlarged cross-sectional view illustrating a portion of the Y cross-sectional view of FIG. 11. FIG. 13 is a bottom view of FIG. 5.

FIG. 11 is similar to FIG. 6 except for the view direction. FIG. 11 shows the arrangement of the zoom motor ZM. FIG. 13 is similar to FIG. 10 and shows the structure of the X stage driving mechanism. Similar to FIG. 10, as can be seen from FIG. 13, the first bent portion FPC3 of the flexible board FPC is appropriately provided in a narrow space.

As such, the XY stage 110 is incorporated with the lens barrel 100 to form the imaging apparatus 1 shown in FIG. 1.

However, in the related art, it is necessary to individually align four guide shafts G1, G3, G4, and G6 and it is difficult to perform the assembly process. In this embodiment, as described above, all of the X stage 113A, the Y stage 113B, and the CCD holder 112 are supported at three points. Therefore, an alignment process is not needed and the assembly process is simplified.

Next, the ease of assembly of the XY stage 110 according to this embodiment will be described with reference to FIG. 5.

As shown in FIG. 5, the X stage 113A and the Y stage 113B are provided so as to surround the central axis. The stages 113A and 113B are supported by the base 111 by fitting the guide shafts G1, G3, G4, and G6 into the U-shaped grooves formed in the base 111. During the process of the base 111, it is easy to obtain the accuracy of squareness and parallelism. Therefore, U-shaped grooves with squareness and parallelism are provided in the base 111 in advance and the guide shafts G1, G3, G4, and G6 and the support shafts G2 and G5 are fitted into the U-shaped grooves. In this way, it is possible to easily obtain the squareness and parallelism of each shaft. According to this structure, it is not necessary to individually adjust the position of each shaft, unlike the related art.

In this way, the first guide shaft G1 passes through two bearings Al and A2 provided in the X stage 113A and both ends of the first guide shaft G1 are fitted to the grooves. In addition, the first support shaft G2 protruding from the first guide shaft G1 in the X direction is also fitted into the grooves. In this way, when the X stage 113A is supported by the base 111 at three points, that is, the bearings A1 and A2 and the support shaft G2, the X stage 113A is supported by the base 111 with high flatness.

The fourth guide shaft G4 passes through two bearings A3 and A4 provided in the Y stage 113B and both ends of the fourth guide shaft G4 are fitted to the grooves. In addition, the second support shaft G5 protruding from the fourth guide shaft G4 in the Y direction is also fitted into the grooves. In this way, when the Y stage 113B is supported by the base 111 at three points, that is, the two bearings A3 and A4 and the support shaft G5, the Y stage 113B is supported by the base 111 with high flatness.

In this way, when the flatness of the X stage 113A and the Y stage 113B is maintained at a high level, it is possible to obtain the CCD holder 112, which is a moving stage, with high flatness by supporting the moving stage with these stages.

In the example shown in FIG. 5, the Y stage 113B includes the second guide shaft G3 that extends in the X direction and is fixedly supported by the Y stage 113B. Therefore, the CCD holder 112, which is a moving stage, includes two bearings B1 and B2 that are supported by the second guide shaft G3 such that they are restricted in the Y direction and are slidable in the X direction and one bearing B3 that is supported by the first guide shaft G1 such that it is not restricted in the X direction and the Y direction. The CCD holder 112 is supported at three points, that is, the two bearings B1 and B2 supported by the second guide shaft G3 and the one bearing B3 supported by the first guide shaft G1. In this way, the position of the CCD holder 112 relative to the base 111 is defined. As shown in FIG. 5, the bearings B1 and B2 have angles in the Z direction and the Y direction, and the bearing B3 has a U shape. In addition, the CCD holder 112 including the CCD plate 116 is urged to the rear side of the plane of FIG. 5 by the spring SP1 provided in the cover member 114. Therefore, the bearings B1, B2, and B3 all define the position of a moving member in the Z direction. As a result, high flatness is obtained.

When the CCD holder 112 is supported at three opposite points, that is, two points of the Y stage 113B with high flatness and one point of the X stage 113A with high flatness which are opposite to each other with the CCD holder 112 interposed therebetween, the CCD holder 112 has high flatness.

Even when the X stage 113A, the Y stage 113B, and the CCD holder 112 have the same degree of flatness as the base 111 by the above-mentioned structure, rattling occurs while the CCD holder 112, which is a moving stage, or the X stage 113A and the Y stage 113B are moved in any direction, when there is a large rattle in the bearing portion. In this case, there is a concern that the X stage 113A and the Y stage 113B will be moved slowly and the CCD holder 112 will be moved slowly.

Therefore, in this embodiment, as described above, a technique has been examined which is capable of minimizing backlash during the sliding of the CCD holder 112, which is a moving stage, using the cover member 114, the spring SP1 provided in the cover member 114, and the shape of the bearings such that backlash can occur during the sliding of the X stage 113A and the Y stage 113B.

As described above, the base 111 includes: two first support portions BE1 and BE2 with a U-groove shape that fixedly support both ends of the first guide shaft G1 and are opened toward the cover member 114; two second support portions BE3 and BE4 with a U-groove shape that fixedly support both ends of the fourth guide shaft G4 and are opened toward the cover member 114; the third support portion BE5 with a U-groove shape that supports the first support shaft G2 so as to be slidable in the X direction and is opened toward the cover member 114; and the fourth support portion BE6 with a U-groove shape that supports the second support shaft G5 so as to be slidable in the Y direction and is opened toward the cover member 114.

In addition, the cover member 114 includes: two first pressing portions that press portions of the first guide shaft G1 supported by the two first support portions BE1 and BE2; two second pressing portions that press portions of the fourth guide shaft G4 supported by the two second support portions BE3 and BE4; the first closing piece that closes an opening of the third support portion BE5 formed toward the cover member 114 and forms the first support hole 114B into which the first support shaft G2 is inserted together with the third support portion BE5; and the second closing piece that closes an opening of the fourth support portion BE6 formed toward the cover member 114 and forms the second support hole 114B into which the second support shaft G5 is inserted together with the fourth support portion BE6.

The cover member 114 is mounted to the surface side of the plane of FIG. 5, that is, in the Z direction so as to cover the X stage 113A, the Y stage 113B, and the CCD holder 112, which is a moving stage, and the bearings are formed by the cover member 114 and the base 111.

FIG. 5 shows the structure of the support portions BE1 to BE6 in order to show the above-mentioned structure.

The first pressing portion and the second pressing portion have the same structure. Therefore, FIG. 5 shows one of the two second support portions BE3 and BE4 supporting the fourth guide shaft G4. As shown in the enlarged view of FIG. 5, the guide shaft G4 is fitted into the U-shaped grooves, and the guide shaft G4 is elastically pressed by the pressing portion 114A, which is a step portion of the cover member 114. In this way, when the first guide shaft G1 and the fourth guide shaft G4 are supported by the first and second support portions, the first guide shaft G1 and the fourth guide shaft G4 are fixedly supported by the base 111.

Since the structures of the third support portion BE5 and the first closing piece are the same as those of the fourth support portion BE6 and the second closing piece, the third support portion BE5 and the first closing piece are shown. As shown in the enlarged view of FIG. 5, the support hole 114B is formed by closing the U-shaped groove with the closing piece of the cover member 114. When the first support shaft G2 and the second support shaft G5 pass through the support holes 114B and are slidably supported, the X stage 113A and the Y stage 113B are supported by the base 111 so as to smoothly slide.

In addition, studies have been focused on connecting portions between the stages 113A and 113B and the CCD holder 112, which is a moving stage. In this embodiment, studies have been focused on the structure supporting the CCD holder 112 at three points and the shapes of three bearings B1, B2, and B3 such that the CCD holder 112 is sensitively moved according to the movement of the X stage 113A and the Y stage 113B.

As described above, the CCD holder 112 is supported at three points, that is, two bearings B1 and B2 that are supported by the second guide shaft G3, which extends in the X direction and is fixedly supported by the Y stage 113B, such that they are restricted in the Y direction and can slide in the X direction, and one bearing B3 that is supported by the first guide shaft G1 such that it is restricted in both the X direction and the Y direction. In this way, the position of the CCD holder 112 relative to the base 111 is defined.

The CCD holder 112 is urged to the rear side of the plane of FIG. 5 by the spring SP1 provided in the cover member 114. Therefore, the bearing B3 of the CCD holder 112 supported by the first guide shaft G1 is opened in the Y direction to form a U-groove-shaped bearing having the first guide shaft G1 provided therein, and the guide shaft is arranged in the U-groove-shaped bearing so as to lean toward one side of the U-groove-shaped bearing. In this way, the position of the CCD holder 112 in the Z direction is defined. In addition, rectangular through holes which have angles in the Z direction and the Y direction and through which the second guide shaft G3 passes are provided in the two bearings B1 and B2 of the CCD holder 112 supported by the second guide shaft G3, and the second guide shaft G3 leans toward one of the through holes. In this way, the CCD holder 112 is supported such that backlash occurring in the Y direction while the CCD holder 112 is moved is absorbed.

A bearing B4 of the CCD holder 112 supported by the third guide shaft G6 may be opened in the Z direction to form a U-groove-shaped bearing having the third guide shaft G6 provided therein, and the third guide shaft G6 may be constantly disposed in the U-shaped groove. In the way, the CCD holder 112 is supported such that the movement of the third guide shaft G6 is not restricted in the Z direction but restricted in the X direction.

As described above, the CCD holder 112 is urged in the X direction by the spring SP2. Therefore, the third guide shaft G6 leans to one side of the U-shaped groove of the bearing B4. In this way, when the CCD holder 112 is moved, rattling in the X direction is absorbed.

The bearing B4 is provided at the position where moment applied from the guide shafts G1 and G3 to the CCD holder 112 when the CCD holder 112 slides in the X direction along the first guide shaft G1 and the second guide shaft G3 is removed. Therefore, the CCD holder 112 is smoothly moved in the X direction.

In this way, it is possible to absorb rattling in the X direction and the Y direction and constantly maintain the position of the CCD holder 112, which is a moving stage, in the Z direction during sliding. Therefore, it is possible to form the XY stage 110 in which the CCD holder 112 can smoothly and rapidly react.

As described above, in the CCD unit 120 according to this embodiment, the CCD 112A is adhered to the CCD plate 116 in a non-contact state (so-called adhesion with a gap). Therefore, the CCD 112A is positioned with respect to the CCD plate 116 without being affected by a part error of the position CCD 112A or the CCD plate 116.

In the imaging apparatus 1 including the CCD unit 120 according to this embodiment, the CCD 112A is positioned with respect to the CCD plate 116 without being affected by a part error of the position CCD 112A or the CCD plate 116. Therefore, it is possible to prevent “deviation of the imaging surface” in which the imaging surface of the CCD 112A does not intersect the optical axis at a right angle but is included with respect to the optical axis due to a part error of the CCD 112A or the CCD plate 116. As a result, it is possible to obtain high positional accuracy of the optical axis.

The imaging apparatus 1 including the CCD unit 120, which is an example of the solid-state imaging unit according to the embodiment of the invention, has been described above.

Next, a CCD fixing method of fixing the CCD plate 116 to the rear surface of the CCD 112A, which is an example of a method of fixing a solid-state imaging device according to an embodiment of the invention, will be described with reference to FIGS. 16 to 18.

FIGS. 16 to 18 are diagrams illustrating a CCD fixing method, which is which is an example of the method of fixing a solid-state imaging device according to the embodiment of the invention.

As shown in FIG. 16, the CCD 112A having the flexible board 115 soldered thereto is supported by a positioning table 210, and the flexible board 115 is arranged between the CCD 112A and the CCD plate 116. In this state, the CCD plate 116 is supported on the rear side of the CCD 112A by the positioning table 210 and the first positioning jig 220 such that it does not contact the CCD 112A. The CCD plate 116 has the through hole 1161 through which the rear surface of the CCD 112A is exposed.

Then, two adjacent sides of the CCD 112A are urged so as to come into contact with a second positioning jig 230, and the CCD 112A is sucked downward through a hole 211 provided in the positioning table 210. In this way, the CCD 112A is positioned. That is, in this embodiment, the CCD 112A and the CCD plate 116 are individually positioned by the first positioning jig 220 and the second positioning jig 230.

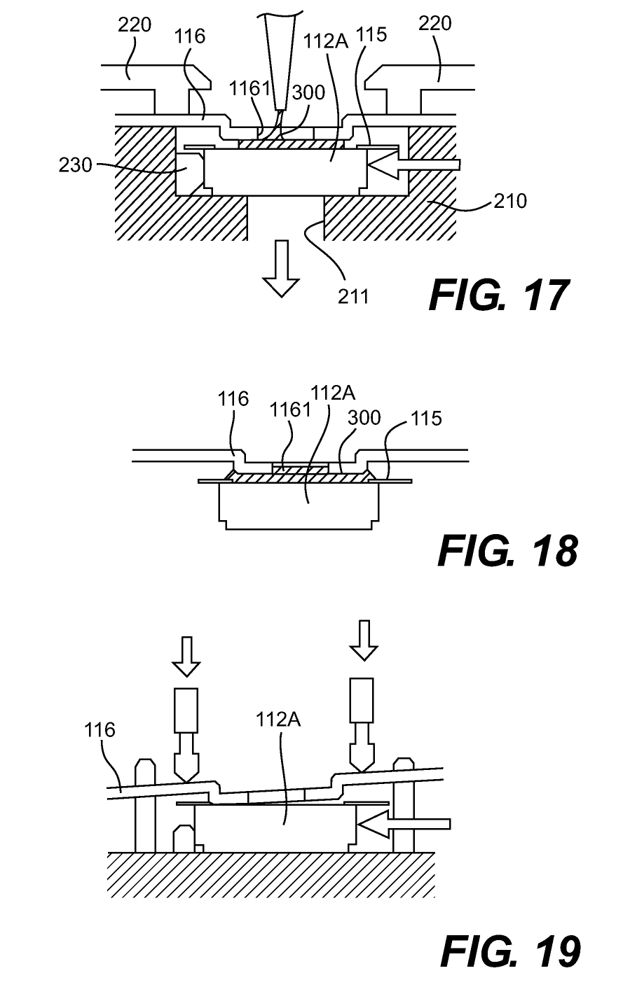

Then, as shown in FIG. 17, the adhesive 300 flows through the through hole 1161 while maintaining the non-contact state between the CCD 112A and the CCD plate 116. Then, as shown in FIG. 18, the CCD 112A and the CCD plate 116 are adhered to each other by the adhesive 300 flowing through the through hole 1161 so as not to contact each other, with the flexible board 115 arranged between the CCD 112A and the CCD plate 116 (so-called adhesion with a gap). The structure including the CCD 112A, the flexible board 115, the CCD plate 116 shown in FIG. 18 corresponds to the CCD unit 120 shown in FIG. 7.

As described above, in the CCD fixing method according to this embodiment, the CCD 112A is positioned with respect to the CCD plate 116 by the positioning table 210, the first positioning jig 220, or the second positioning jig 230, without being affected by a part error of the CCD 112A or the CCD plate 116.

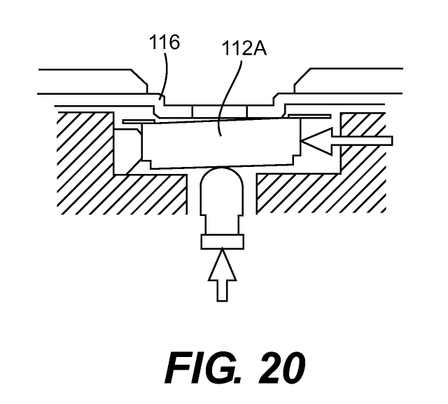

In the CCD fixing method according to this embodiment, the adhesive 300 flows through the through hole 1161 to adhere the CCD and the CCD plate 116 with a gap therebetween. Therefore, for example, a process error, such as a positional deviation of the CCD 112A or the CCD plate 116, in the fixing method according to the related art shown in FIGS. 19 and 20 is less likely to occur. As a result, it is possible to reliably position the CCD 112A with respect to the CCD plate 116.

The CCD fixing method, which is an example of the method of fixing the solid-state imaging device according to the embodiment of the invention, has been described above.

In the above-described embodiment, the solid-state imaging device is the CCD, but the solid-state imaging device according to the invention is not limited thereto. For example, the solid-state imaging device may be a CMOS image sensor.

In the above-described embodiment, the solid-state imaging unit according to the invention includes the solid-state imaging device (CCD), the flexible board, and the supporting member (CCD plate). However, the solid-state imaging unit is not limited thereto, but it may include at least a solid-state imaging device and a supporting member.

What is claimed is:

1. A solid-state imaging unit comprising:
a solid-state imaging device that receives object light and generates image signals indicating an object image; and
a supporting member that is provided on the rear side of the solid-state imaging device so as not to contact the solid-state imaging device,
wherein the solid-state imaging device and the supporting member are adhered to each other in a non-contact state.

2. The solid-state imaging unit according to claim 1,
wherein the supporting member has a through hole through which the rear surface of the solid-state imaging device is exposed, and
the solid-state imaging device and the supporting member are adhered to each other in the non-contact state by an adhesive flowing through the through hole.

3. An imaging apparatus that has an imaging optical system and captures an image using object light incident through the imaging optical system, comprising:
a solid-state imaging device that receives the object light and generates image signals indicating an object image; and
a supporting member that is provided on the rear side of the solid-state imaging device so as not to contact the solid-state imaging device,
wherein the solid-state imaging device and the supporting member are adhered to each other in a non-contact state.

4. The imaging apparatus according to claim 3,
wherein the supporting member has a through hole through which the rear surface of the solid-state imaging device is exposed, and
the solid-state imaging device and the supporting member are adhered to each other in the non-contact state by an adhesive flowing through the through hole.

5. A method of fixing a solid-state imaging device, comprising:
supporting a solid-state imaging device that receives object light and generates image signals indicating an object image and supporting a supporting member on the rear side of the solid-state imaging device so as not to contact the solid-state imaging device;
positioning the solid-state imaging device; and
adhering the solid-state imaging device and the supporting member in non-contact state.

6. The method of fixing a solid-state imaging device according to claim 5,
wherein the supporting member has a through hole through which the rear surface of the solid-state imaging device is exposed, and
the solid-state imaging device and the supporting member are adhered to each other in the non-contact state by an adhesive flowing through the through hole.
